(19) United States
(12) Patent Application Publication
(10) Pub. No.: US 2009/0087212 A1
(43) Pub. Date: Apr. 2, 2009

(54) CHARGING DEVICE

(75) Inventor: Motohiro Ogura, Kashiwa-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/212,941

(22) Filed: Sep. 18, 2008

(30) Foreign Application Priority Data
Sep. 27, 2007 (JP) 2007-250835

(51) Int. Cl. G03G 15/02

(52) U.S. Cl. 399/100

(57) ABSTRACT

A charging device includes a charging roller for electrically charging a photosensitive member. The charging roller alternately has pits and projections along a circumferential direction thereof. The projections project in an inclined direction in which the projections are inclined with respect to a radial direction of the charging roller. The charging device further includes a roller rotating mechanism for rotating the charging roller to provide a peripheral movement thereof in a sense from the radial direction toward the inclined direction, a brush for cleaning the charging roller, and a brush rotating mechanism for rotating the brush to provide a peripheral movement thereof counterdirectionally with the inclined direction at a position in which the brush and the charging roller contact each other.

### FIELD OF THE INVENTION AND RELATED ART

The present invention relates to a charging device for use in an image forming apparatus such as a copying machine, a printer, a facsimile machine, or a multi-function machine having a plurality of functions of these machines.

In a conventional electrophotographic image forming apparatus, a photosensitive member is uniformly charged electrically by using a charging roller disposed so as to be rotated by the photosensitive member. Specifically, the photosensitive member is electrically charged by applying a superposed charging bias of a DC voltage and an AC voltage to a core metal of the charging roller to utilize an electric discharge phenomenon occurring in the neighborhood of a contact portion between the charging roller and the photosensitive member.

In recent years, with improvement in image forming speed of the image forming apparatus, service life extension of various devices is desired, so that the service life extension is also similarly desired with respect to the charging roller.

As a factor of a lowering in service life of the charging roller, there is charging roller contamination by transfer of contaminants, such as external additives added to toner and toner itself, from the photosensitive member. Such charging roller contamination leads to a lowering in charging power or charging non-uniformity.

When the charging roller is produced, the charging roller has been subjected to polishing so that the charging roller can have circularity and a diameter with high accuracy. By such polishing, on a surface of the charging roller, pits and projections (hereinafter referred to as “grain of polish trace”) are formed and a direction of the projections is deviated from a radial direction (Japanese Laid-Open Patent Application (JP-A) 2000-172055).

In an apparatus described in JP-A 2000-172055, a cleaning pad is brought into contact with the charging roller on which the grain of polish trace is formed to effect cleaning of the charging roller.

However, in the case of the charging roller on which the grain of polish trace is formed, the charging roller cannot be cleaned sufficiently by the above-described cleaning pad. Specifically, the above-described contaminants such as external additives and the like are liable to remain in spaces (recesses) of the grain of polish trace formed on the charging roller, so that the contaminants remaining in the spaces (recesses) cannot be appropriately removed by the cleaning pad. Therefore, in the conventional constitution, the service life extension of the charging roller cannot be achieved.

JP-A Hei 5-265307 and JP-A 2005-4065 propose a cleaning device, using a rotatable brush, for a charging roller. However, only by simply applying such a cleaning device to the charging roller on which the grain of polish trace is formed, defective cleaning occurs. That is, the contaminants remaining in the spaces (recesses) of the grain of polish trace formed on the charging roller cannot be removed appropriately.

### SUMMARY OF THE INVENTION

A principal object of the present invention is to provide a cleaning device capable of stably retaining charging power (performance) of a charging roller for a long term by effectively cleaning a surface of the charging roller.

According to an aspect of the present invention, there is provided a charging device comprising:

a charging roller for electrically charging a photosensitive member, the charging roller alternately having pits and projections along a circumferential direction thereof, wherein the projections project in an inclined direction in which the projections are inclined with respect to a radial direction of the charging roller;

a roller rotating mechanism for rotating the charging roller to provide a peripheral movement thereof in a sense from the radial direction toward the inclined direction;

a brush for cleaning the charging roller; and

a brush rotating mechanism for rotating the brush to provide a peripheral movement thereof counterdirectionally with the inclined direction at a position in which the brush and the charging roller contact each other.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic sectional view of a charging roller.

FIG. 2 is a photograph, of an example of grain of polish trace formed on the charging roller, taken by an ultradeep shape measuring microscope and a profile of the grain of polish trace.

FIG. 3 is an enlarged view of the grain of polish trace formed on the charging roller.

FIG. 4 is a schematic sectional view of a brush roller.

FIG. 5 is a perspective view for illustrating a structure of the brush roller.

FIG. 6 is a schematic view for measuring a free end force of the brush roller.

FIG. 7 is a schematic sectional view of an image forming apparatus.

FIGS. 8(a) and 8(b) are schematic sectional views each for illustrating a layer structure of a photosensitive member.

FIG. 9 is a schematic output chart by FISHERSCOPE H100V (mfd. by H. Fisher GmbH).

FIG. 10 is a schematic view for illustrating a rotating mechanism for the charging roller and the brush roller.

### DESCRIPTION OF THE PREFERRED EMBODIMENTS

Hereinbelow, embodiments of the present invention will be described in detail. It should be understood that a device constitution, constituent elements or means, and dimensions, materials, shapes, relative arrangement, and the like of the constituent elements or means of an image forming apparatus in the present invention are not limited to those described in the following embodiments or examples unless otherwise specified.

### [Image Forming Apparatus]

FIG. 7 is a schematic view for illustrating an example of a structure of an image forming apparatus. This image forming apparatus is an electrophotographic image forming apparatus using a drum-type electrophotographic photosensitive member 1 as an image bearing member.

The photosensitive member 1 is supported and disposed rotatably about an axial line and is rotationally driven at a predetermined speed in a clockwise direction indicated by an arrow by a motor M (FIG. 10) as a rotating mechanism.

The surface of the rotating photosensitive member 1 is electrically charged uniformly to a predetermined polarity and a predetermined potential by a charger. In this embodiment, the charger is a contact charger using a charging roller 2. The charging roller2 is an electroconductive elastic roller including a core metal 21 as an electroconductive support and an electroconductive elastic layer provided on the core metal. Both longitudinal end portions of the core metal of the charging roller are supported rotatably by a main assembly frame of the image forming apparatus via bearing members, so that an axial line of the charging roller 2 is provided in substantially parallel to that of the photosensitive member 1. Further, the charging roller 2 is configured to contact the photosensitive member 1 by pressing of the both longitudinal end portions of the core metal 21 with a predetermined pressing force. Further, both end portions of the core metal 21 are pressed against the photosensitive member by springs 100a and 100b (FIG. 10) so that the charging roller can be rotated by the photosensitive member 1 by the contact of the charging roller 2 with the photosensitive member 1.

In this embodiment, on the surface of the charging roller 2, grain of polish trace is formed. Details thereof will be described later.

A rotatable brush (cleaning brush) 41 as a cleaning member for cleaning the surface of the charging roller 2 prevents the charging roller surface from being contaminated locally or entirely with contaminants by removing the contaminants deposited on the charging roller surface. Details of the rotatable brush 41 will be also described later.

To the core metal of the charging roller 2, a charging bias is applied from a charging bias applying power source portion S1 (FIG. 7), so that the photosensitive member is electrically charged uniformly by this charging bias. As a charging bias application method, it is possible to employ a DC charging method in which a predetermined DC voltage is applied as the charging bias and an AC+DC charging method in which a voltage in the form of a predetermined DC voltage biased with a predetermined AC voltage is applied as the charging bias but in this embodiment, the AC+DC charging method is employed from the viewpoint of charging uniformity. As a result, the surface of the rotating photosensitive member 1 is contact-charged uniformly to a predetermined polarity and a predetermined potential. In this embodiment, the surface of the photosensitive member 1 is electrically charged to a predetermined negative potential (e.g., −500 V).

Then, the charged surface of the photosensitive member 1 is subjected to image exposure by an image exposure device 3 (FIG. 7). As a result, a potential of an exposed portion on the photosensitive member surface is attenuated, so that an electrostatic latent image corresponding to image information is formed on the photosensitive member surface. The image exposure device 3 may be an analog exposure device for performing image projecting exposure of an original image or a digital exposure device such as a laser scanner or an LED array. In this embodiment, a laser scanner for effecting laser scanning exposure with light L having a wavelength λ=780 nm is used.

The electrostatic latent image formed on the photosensitive member surface is developed as a toner image by a developing device 4 (FIG. 7). In this embodiment, the developing device 4 contains negatively chargeable magnetic toner as a developer and effects reverse development. The developing device 4 includes a developing sleeve 5 and a hopper portion 6 for supplying the developer to the developing sleeve 5 and is disposed so that a gap between the developing sleeve 5 and the photosensitive member 1 is kept at 0.3 mm. To the developing sleeve 5, a predetermined superposed voltage of an AC voltage component and a DC voltage component is applied from a developing bias application power source portion S2 during the development.

The toner image formed on the photosensitive member surface is conveyed to a transfer portion T by further rotation of the photosensitive member 1 and is transferred onto a recording material P fed to the transfer portion T by a transfer roller 7. The transfer roller 7 is an electroconductive elastic layer. Both end portions of a roller shaft of the transfer roller 7 are rotatably supported via bearing members and a roller axial line is disposed in substantially parallel to the axial line of the photosensitive member 1, so that the transfer roller 7 is disposed in contact with the photosensitive member 1 with a predetermined pressing force. In this embodiment, the transfer roller 7 is rotated by the rotation of the photosensitive member 1. The recording material P is fed from a sheet feeding mechanism portion (not shown) with a predetermined control timing and is guided to the transfer portion T with an appropriate timing in synchronism with a timing of image formation on the photosensitive member 1 by using registration rollers 8 while being nip-conveyed between the photosensitive member 1 and the transfer roller 1. To the transfer roller 7, a DC voltage which has a predetermined potential and a polarity opposite from the charge polarity of the toner is applied from a transfer bias application power source portion S3 during passing of the recording material P through the transfer portion T. In this embodiment, a positive DC voltage is applied. As a result, a positive electric charge is imparted to a back surface of the recording material P (a surface opposite from a front surface facing the photosensitive member) at the transfer portion T, so that the toner image on the surface of the photosensitive member is electrostatically transferred successively onto the (front) surface of the recording material P.

The recording material P on the toner image is transferred is guided into a fixing device 11 by a conveyer belt 10. The fixing device 11 in this embodiment is a heat fixing device including a roller pair consisting of a heat roller 12 and a pressing roller 13. The recording material P guided into the fixing device enters a fixing portion N, which is a press-contact nip of the roller pair 12 and 13, and is nip-conveyed through the fixing portion N. As a result, an unfixed toner image on the recording material P is fixed on the surface of the recording material P by heat and pressure and thereafter is discharged outside the main assembly of the image forming apparatus as a print.

The surface of the photosensitive member 1 is subjected to removal of residues such as transfer residual toner and paper powder by a cleaning device 14, thus being subjected to image formation repetitively. In this embodiment, the cleaning device 14 is a blade cleaning device using a cleaning blade 15. The surface of the photosensitive member is rubbed with the cleaning blade 15, so that the residues are removed from the surface of the photosensitive member. The thus removed residues are contained in a residual toner containing portion 16.

### Photosensitive Member 1

Details of the photosensitive member 1 will be described. A constitution of the photosensitive member 1 is not limited to that described later but may also be other constitutions.

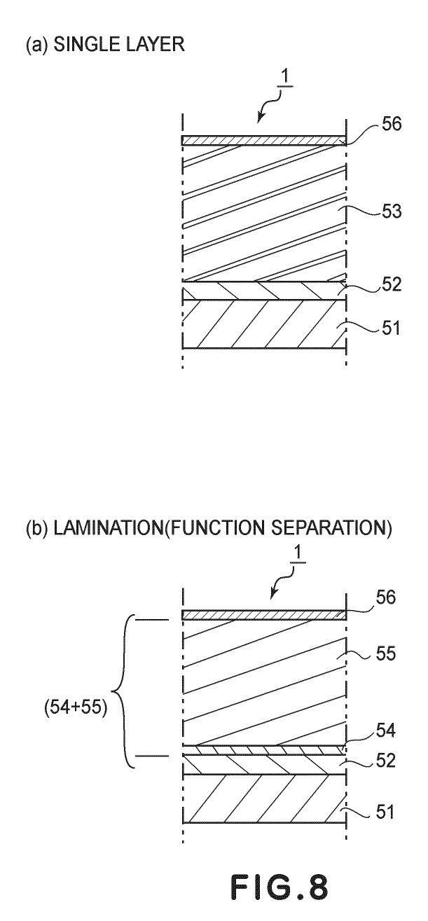

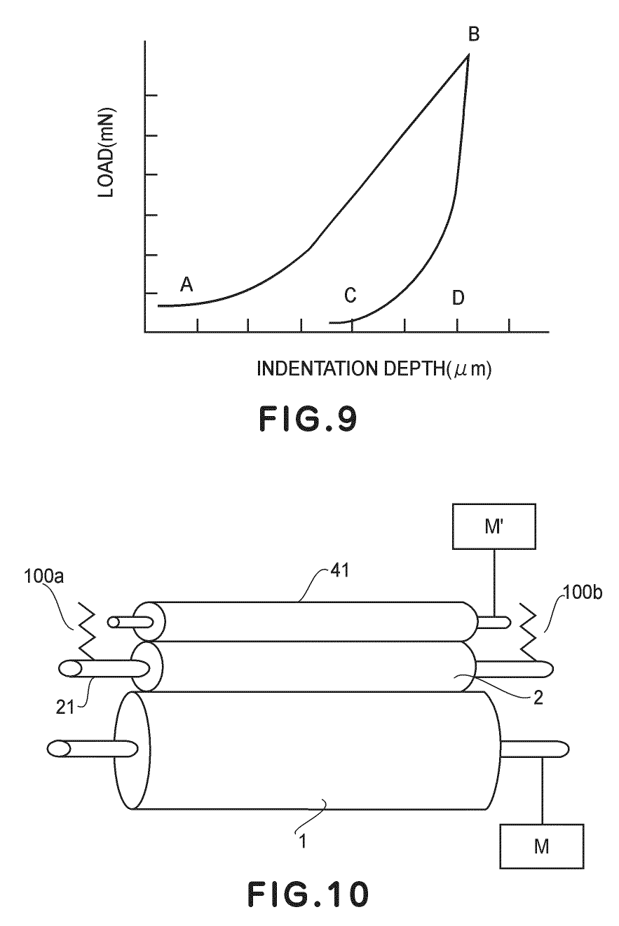

In this embodiment, an example of the photosensitive member 1 increased in service life by providing a surface protection layer will be described with reference to FIGS. 8A, 8B and 9. A universal hardness (value) HU and an elastic deformation ratio of an surface protection layer 56 of the photosensitive member 1 were measured by using a microhardness measuring device (“FISHERSCOPE H100V”, mfd. by Fisher GmbH) in which a load was successively applied to an indenter and under the load an indentation depth to obtain successive hardness. The indenter used was a Vickers quadrangular pyramid diamond indenter with an angle between opposite faces of 136 degrees. The measurement was performed under a load in such a manner that the load was stepwisely increased up to a final load of 6 mN at 273 levels each with a retention time of 0.1 sec.

A schematic output chart is shown in FIG. 9. In FIG. 9, an ordinate represents a load (mN) and an abscissa represents an indentation depth h (μm). The output chart is a result such that the load is applied by increasing stepwisely the load up to 6 mN and thereafter decreasing stepwisely the load.

The universal hardness value HU is defined by the following formula (1) from the indentation depth of the indenter under a test load of 6 mN.

HU=(test load)(N)/(surface area of Vickers indenter under test load)(mm²)=0.006/26.43 h²(N/mm²) (1)

In the formula (1), h represents an indentation depth (mm) under the test load.

The elastic deformation ratio is obtained from a change in an amount of work (energy) of the indenter on a film, i.e., a change in energy caused by increase and decrease of the load of the indenter on the film. A value of the elastic deformation ratio is obtained from a formula (2) shown below. An entire amount of work Wt (nW) is represented by an area enclosed by A-B-D-A shown in FIG. 9 and an elastic deformation amount of work We (nW) is represented by an area enclosed by C-B-D-C shown in FIG. 9.

Elastic deformation ratio=(We/Wt)×100 (%)

As a performance required to the organic electrophotographic photosensitive member, there is an improvement in durability against mechanical deterioration.

It is generally considered that the hardness of the film is larger with a smaller amount of deformation with respect to external stress and naturally the electrophotographic photosensitive member is also improved in the durability with respect to the mechanical deterioration in the case where the photosensitive member has high pencil hardness or high Vickers hardness. However, a photosensitive member having high hardness values obtained by measuring these hardnesses has not always realized the improvement in durability.

As a result of study, the present inventor has found that the mechanical deterioration of the surface protection layer 56 is less liable to occur in the case where each of the values of the universal hardness HU and the elastic deformation ratio is within a certain range. That is, as a result of a hardness test performed by using the Vickers quadrangular pyramid diamond indenter, the mechanical deterioration of the surface protection layer 56 was drastically improved by using an electrophotographic photosensitive member having a universal hardness HU of 150 N/mm² or more and 220 N/mm² or less and an elastic deformation ratio of 40% or more and 65% or less when the surface protection layer 56 is indented with the indenter under a maximum load of 6 mN. IN order to further improve the characteristic, it is preferable that the HU value is 160 N/mm² or more and 200 N/mm² or less.

The HU value and the elastic deformation ratio value cannot be considered separately from each other. However, e.g., when the HU value exceeds 220 N/mm³ and the elastic deformation ratio value is less than 40%, an elastic force of the photosensitive member against the paper powder or the toner sandwiched between the photosensitive member and the cleaning blade or the charging roller is insufficient. For that reason, as a result, a large pressure is locally applied, so that deep damage occurs. Further, in the case where the elastic deformation ratio value is larger than 65%, even when the elastic deformation ratio value is large, an amount of elastic deformation is small. Consequently, the large pressure is locally applied, so that the deep damage occurs. Therefore, it is considered that the high HU value is not necessarily optimum for the photosensitive member.

Further, in the case where the HU value is less than 150 N/mm² and the elastic deformation ratio value exceeds 65%, even when the elastic deformation ratio is high, an amount of plastic deformation is also large. For that reason, the photosensitive member is rubbed with the paper powder or the toner sandwiched between the photosensitive member and the cleaning blade or the charging roller, so that scraping or fine damage of the photosensitive member occurs.

When the service life extension of the photosensitive member 1 used in this embodiment is considered, the photosensitive member 1 is comprised of an electrophotographic photosensitive member having the surface protection layer 56 containing at least a compound cured (or hardened) by polymerization or cross-linking. As a curing means, it is possible to use heat, light such as visible light or ultraviolet rays, and radiation.

Therefore, in this embodiment, as a method of forming the surface protection layer 56 of the photosensitive member, an application solution, in which a compound curable by polymerization or cross-linking is fused or contained, used for the surface protection layer is used. After the application solution is applied by a dip coating method, a spray coating method, a curtain coating method, a spin coating method, or the like, the applied compound is cured by the curing means.

Of these methods, as a method of efficiently mass-producing the photosensitive member, the dip coating method is most preferable and it is possible to employ the dip coating method also in this embodiment. The above-described surface protection layer 56 is intended to extend the service life but the surface protection layer 56 usable in the present invention is not limited thereto.

A schematic structure of the photosensitive member 1 will be described with reference to FIGS. 8A and 8B, wherein FIG. 8A shows a schematic structure of a single layer-type photosensitive member 1 and FIG. 8B shows a lamination-type photosensitive member 1.

The single layer-type photosensitive member 1 shown in FIG. 8A has a layer structure in which both of a charge generating substance and a charge transport substance are contained in the same layer (photosensitive layer) 53 formed on or above an electroconductive substrate (supporting member) 51 having an outer diameter of, e.g., 30 mm. The lamination-type photosensitive member 1 shown in FIG. 8B has a layer constitution in which a charge generating layer 54 containing the charge generating substance and a charge transport layer 55 containing the charge transport substance are laminated in this order or a reverse order. The layers 54 and 55 constitutes a photosensitive layer. On the photosensitive layer 53 (FIG. 8A) or 54+55 (FIG. 8B), it is possible to form the surface protection layer 56.

Further, in order to optimize a thickness of the charge transport layer, the surface protection layer 56 may preferably be used in a sense that a latitude in thickness is given. At least the surface layer of the photosensitive member may contain a compound capable of being cured by heat, light such as visible light or ultraviolet rays, or radiation.

From viewpoints of characteristics of the photosensitive member, particularly an electrical characteristic such as residual potential and durability, the lamination-type photosensitive member shown in FIG. 8B is preferable. That is, a constitution of a functionally-separated type photosensitive member in which the charge generating layer 54 and the charge transport layer 55 are successively laminated to form the photosensitive layer or a constitution in which the surface protection layer 56 is formed on the photosensitive layer of the functionally-separated type photosensitive member is preferred.

As a curing method of the compound in the surface protection layer 56 through the polymerization or the cross-linking, the radiation may suitably be employed because of less deterioration of the photosensitive member characteristics, no occurrence of an increase in residual potential, and ensuring of sufficient hardness.

As the radiation used during generation of the polymerization or the cross-linking, electron beam or gamma ray may desirably be used. Of these, in the case of using the electron beam, it is possible to use an accelerator of any types such as a scanning type, an electron curtain type, a broad beam type, a pulse type, and a laminar type.

Further, in the case of irradiation with the electron beam, in order to exhibit the electrical characteristic and the durability of the photosensitive member, as an irradiation condition, it is preferable that an acceleration voltage is 250 kV or less, more preferably 150 kV or less. Further, an exposure (exposure dose) may preferably be in the range from 10 kJ/kg to 1000 kJ/kg, more preferably in the range from 15 kJ/kg to 500 kJ/kg.

When the acceleration voltage is larger than the above-described upper limit, damage to the photosensitive member characteristics by the electron beam irradiation is liable to increase. Further, the exposure is less than the lower limited of the above-described range, a degree of the curing is liable to become insufficient. In the case where the exposure is large, the deterioration of the photosensitive member characteristics is liable to occur. For this reason, from this viewpoint, the exposure may desirably be selected from the above-described range.

As the compound, for the surface layer, curable by causing the polymerization or the cross-linking, compounds containing an unsaturated polymerizable functional group in molecule may preferably be used from viewpoints of high reactivity, high reaction speed, and high hardness achieved after the curing.

Of these compounds containing the unsaturated polymerizable functional group in molecule, compounds having acrylic group, metharylic group, and styrene group may particularly be preferred.

The compound having the unsaturated polymerizable functional group is roughly classified into a monomer and oligomer depending on a state of recurrence of constitutional unit thereof. The monomer refers to a compound with no recurrence of a structural unit having the unsaturated polymerizable functional group, thus having a relatively small molecular weight. On the other hand, the oligomer refers to a polymer having the number of recurrence, of the structural unit having the unsaturated polymerizable functional group, of about 2-20. Further, it is also possible to use a so-called macronomer, in which the unsaturated polymerizable functional group is connected to only a terminal of a polymer or the oligomer, as the curable compound for the surface layer.

As the compound having the unsaturated polymerizable functional group, in order to satisfy a charge transport function required as the surface layer, it is more preferable that a charge transfer compound is employed. Of the charge transfer compound, an unsaturated polymerizable compound having a hole transport function is further preferred.

As the electroconductive support 51 of the electrophotographic photosensitive member, any material may be used so long as it has electroconductivity. Specifically, the support may be formed, in a body shape or a sheet-like shape, of metals such as aluminum, copper, chromium, nickel, zinc, and stainless steel or alloys thereof. Further, it is also possible to use a laminate of a metal foil of aluminum, copper, or the like and a plastic film, and a plastic film on which aluminum, indium oxide, tin oxide, or the like is deposited. It is further possible to use metal, a plastic film, or paper which are provided thereon with an electroconductive layer formed by applying an electroconductive substance singly or together with a binder resin material.

On the surface of the electroconductive support 51, it is possible to provide an under coating layer 52 having a barrier function and an adhesive function.

The under coating layer 52 is formed for improving an adhesive property of the photosensitive layer 53 or 54+55, improving a coating property of the photosensitive layer 53 or 54+55, protecting the support 51, coating a defect on the support 51, improving a charge injection property from the support 51, or protecting the photosensitive layer 53 or 54+55 from electrical breakdown.

As a material for the under coating layer 52, it is possible to use polyvinyl alcohol, poly-N-vinylimidazole, polyethylene oxide, ethyl cellulose, ethylene-acrylic acid copolymer, casein, and polyamide. Further, it is also possible to use N-methoxymethyl 6-nylon, copolymer nylon, glue, and gelatine. These materials are dissolved in an appropriate solvent and then are applied onto the surface of the support 51. A thickness of the undercoating layer 52 may suitably be 0.1-2 μm.

In the case where the photosensitive member is of the functionally-separated type, the charge generating layer 54 and the charge transport layer 55 are laminated.

As the charge generating substance used for the charge generating layer 54, it is possible to use selenium-tellunium (Se—Te) alloy, pyrilium dyes, and thiapyrylium dyes. Further, it is possible to use phthalocyanine compounds having various center metal elements and crystal systems such as α type, β type, γ type, ε type, and × type; anthoanthorone pigments; dibenzpyrenequinone pigments; pyranthorone pigments; and trisazo pigments. It is also possible to use disaze pigments, monoazo pigments, indigo pigments, quinacridone pigments, asymmetrical quinocyanine pigments, quinocyanine, and amorphous silicon.

Further, in the case of the functionally-separated type photosensitive member, for preparing the charge generating layer 54, the charge generating substance is satisfactorily dispersed together with a binder resin material and a solvent, in an amount which is 0.3-4 times that of the charge generating substance, by dispersing means such as a homogenizer, an ultrasonic dispersing device, a ball mill, a vibratory ball mill, a sand mill, an attritor, and a roll mill. Then, the dispersion is applied and dried to form the charge generating layer 54. Alternatively, the charge generating layer 54 is formed as a single constituent film such as a vapor-deposited film of the charge generating substance. A thickness of the charge generating layer 54 is typically 5 μm or less, preferably 0.1-2 μm.

Examples of the binder resin material used may include polymers and copolymers of vinyl compounds such as styrene, vinyl acetate, vinyl chloride, acrylates, methacrylates, vinylidene fluoride, and trifluoroethylene. Further, it is also possible to use polyvinyl alcohol, polyvinyl acetal, polycarbonate, polyester, polysulfone, polyphenylene oxide, polyurethane, cellulose resin, phenolic resin, melamine resin, silicone resin, and epoxy resin.

The hole transport compound having the unsaturated polymerizable functional group can be used as the material for the charge transport layer 55 formed on the above-described charge generating layer 54. Alternatively, the hole transport compound can also be used as a material for the surface protection layer 56 after the charge transport layer 55 consisting of the charge transport substance and a binder resin material is formed on the charge generating layer 54.

In the case of using the hole transport compound as the material for the surface protection layer 56, for preparing the charge transport layer 55 as an underlying layer of the surface protection layer 56, an appropriate charge transport substance is dispersed or dissolved in a solvent together with an appropriate binder resin material selectable from the above-described binder resin material for the charge generating layer 54. Then, the dispersion or solution can be applied and dried by the above-described known methods to form the charge transport layer 55.

As the charge transport substance, it is possible to use polymeric compounds, having a heterocycle or a fused polycyclic aromatic group, such as poly-N-vinylcarbazole and polystyrylanthracene. It is also possible to use heterocyclic compounds such as pyrazoline, imidazole, oxazole, triazole, and carbazole. It is further possible to use low-molecular weight compounds including triarylamine derivatives such as triarylamine; phenylenediamine derivatives; N-phenylcarbazole derivatives; stilbene derivatives; and hydrazone derivatives.

In this embodiment, a thickness of the charge transport layer 55 is in a range of 10-30 μm.

In either case, the surface protection layer 56 is generally formed by applying a solution containing the hole transport compound and then effecting a polymerization reaction or a curing reaction. It is also possible to form the surface protection layer 56 by obtaining a cured product in advance through a reaction of the solution containing the hole transport compound and thereafter using a dispersion or solution of the cured product dispersed or dissolved in a solvent.

As a method of applying (coating) the above-described dispersion or solution, a dip coating method, a spray coating method, a curtain coating method, a spin coating method, and the like have been known. From viewpoints of efficiency and productivity, as the solution (dispersion) coating method, it is desirable that the dip coating method is used. Incidentally, it is also possible to appropriately select other known film-forming methods.

In the surface protection layer 56, it is also possible to mix electroconductive particles. As the electroconductive particles, it is possible to use particles of metal, metal oxide, and carbon black.

As the metal for the electroconductive particles, it is possible to use specifically aluminum, zinc, copper, chromium, nickel, stainless steel, and silver. Further, as the electroconductive particles, it is possible to use plastic particles on which surfaces these metals are (vapor-)deposited.

As the metal oxide for the electroconductive particles it is possible to use specifically zinc oxide, titanium oxide, tin oxide, antimony oxide, indium oxide, and bismuth oxide. Further, it is also possible to use tin-doped indium oxide, antimony-doped tin oxide, and antimony-doped zirconium oxide.

These metal oxides can be used singly or in combination of two or more species. Incidentally, in the case of combining the two or more species of the metal oxides, the metal oxides can be mixed simply or can also be formed in a solid solution or subjected to fusion.

The electroconductive particles may preferably have an average particle size of 0.3 μm or less, more preferably 0.1 μm or less, from a viewpoint of transparency of the surface protection layer 56. Further, of the above-described materials for the electroconductive particles, it is particularly preferable that the metal oxide is used from the viewpoint of transparency or the like.

A ratio of the electroconductive metal oxide particles to the surface protection layer 56 is one of factors directly determining a resistance of the surface protection layer 56. Therefore, a resistivity of the surface protection layer 56 may desirably be in a range of 10⁸−10¹³ Ωm (10¹⁰−10¹⁵ Ωcm).

In the surface protection layer 56, fluorine-containing resin particles can also be contained. As the fluorine-containing resin particles, it is possible to use particles of tetrafluoroethylene resin, chlorotrifluoroethylene resin, tetrafluoroethylene-propylene resin, vinyl fluoride resin, vinylidene fluoride resin, dichlorodifluoroethylene resin, and copolymers of these. It is preferable that at least one species of the resin materials for the fluorine-containing resin particles is appropriately selected from those described above.

As the above-described fluorine-containing resin particles, the particles of the tetrafluoroethylene resin and the vinylidene fluoride resin are particularly preferred. A molecular weight of the resin material for the fluorine-containing resin particles and a particle size of the resin particles can be appropriately selected.

A ratio of the fluorine-containing resin particles in the surface protection layer 56 is typically 5-40 wt. %, preferably 10-30 wt. %, per the entire weight of the surface protection layer 56. This is because the surface layer is liable to lower in mechanical strength when the ratio of the fluorine-containing resin particles is more than 40 wt. % and there is a possibility that surface-parting property, anti-wearing property, and damage-resistant property of the surface layer are insufficient when the ratio is less than 5 wt. %.

In order to further improve dispersibility, binding property and weather-resistant property, it is also possible to add an additive such as a radical scavenger or an antioxidant in the surface protection layer 56. A thickness of the surface protection layer 56 may suitably be in a range of 0.2-10 μm, preferably 0.5-6 μm.

### [Charging Roller 2]

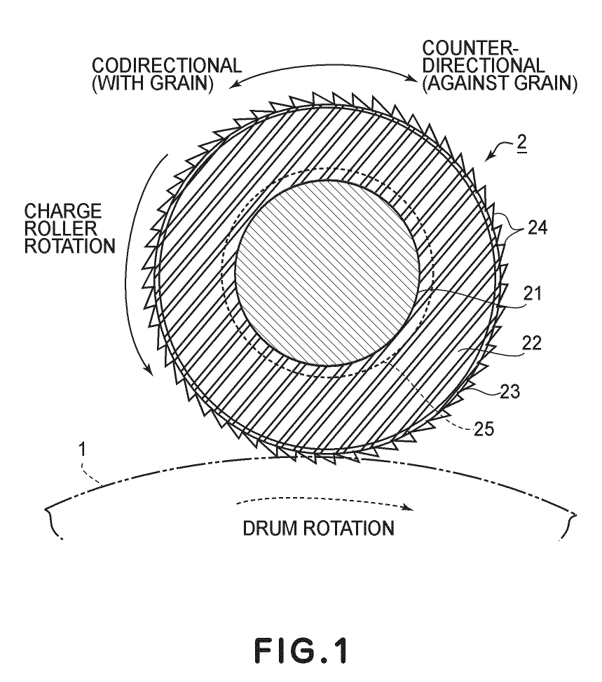

FIG. 1 is a schematic cross-sectional view of the charging roller 2 in this embodiment. As shown in FIG. 1, at the surface of the charging roller 2, grain of polish trace is formed by polishing during production.

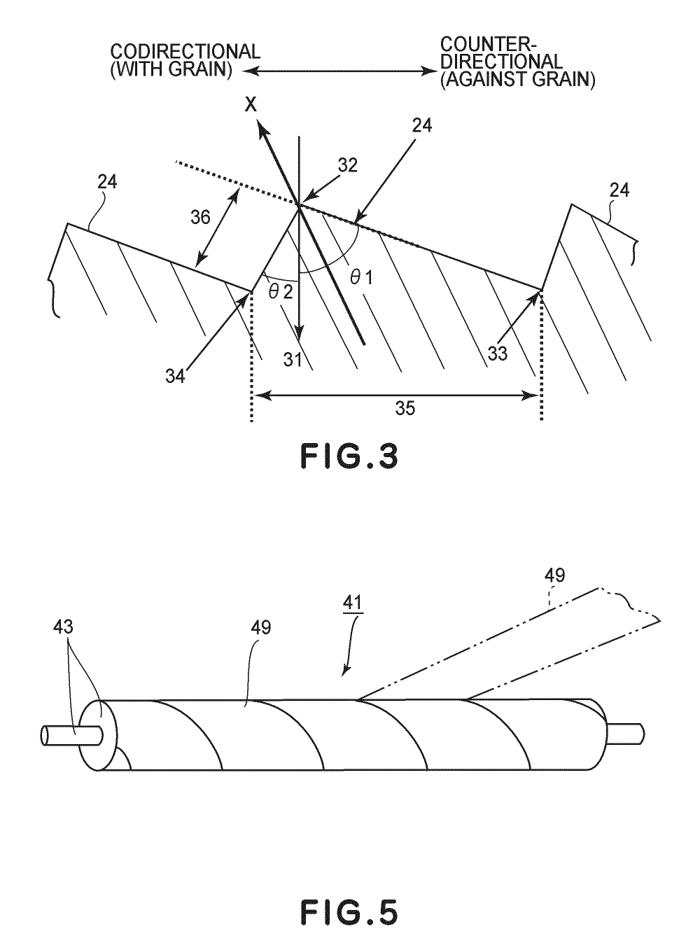

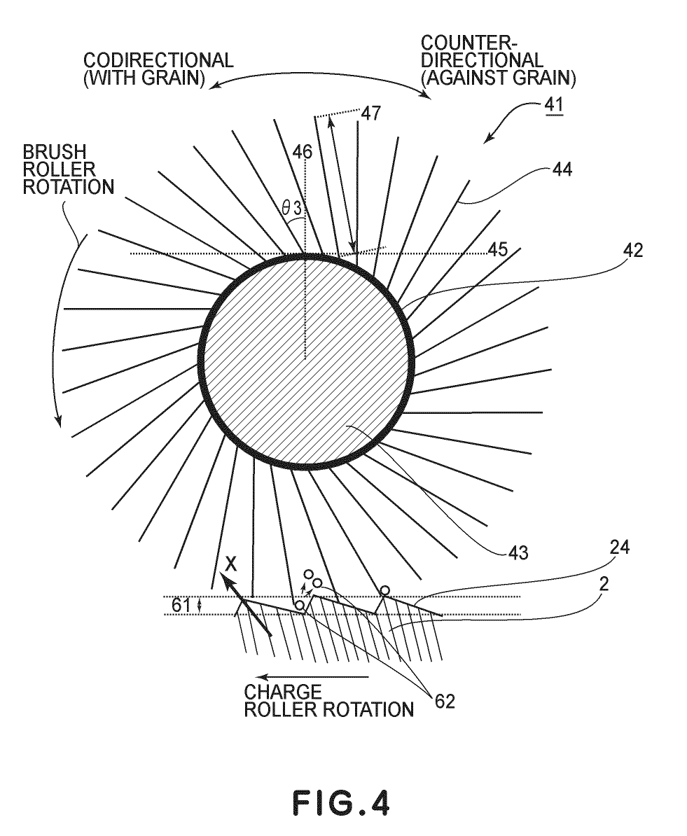

This charging roller 2 is constituted by a core metal 21 as an electroconductive support, an electroconductive elastic layer 22 laminated on an outer peripheral surface of the core metal 21, and a surface treatment layer (post-processing layer) 23. The surface treatment layer 23 is a polished layer of the surface of the electroconductive elastic layer 22. Therefore, the charging roller 2 has regular pits and projections by being polished along a circumferential direction and has a surface shape such that a direction of the projections is slanted with respect to a radial direction of the charging roller 2. With respect to the direction of the grain of polish trace, a direction in which a member moves or rotates with grain is a codirectional direction and a direction in which the member mover or rotates against grain is a counterdirectional direction. The direction of the projections refers to a direction of an arrow X indicated in FIGS. 3 and 4 schematically showing the grain of polish trace at the surface of the charging roller 2. That is, the arrow X direction is parallel to a direction of a line which bisects an apex angle (θ1+θ2) of an apex portion constituting the grain of polish trace.

A reference numeral 24 represents a schematically illustrated grain of polish trace caused by polishing. Referring to FIG. 1, the charging roller 2 contacts the photosensitive member 1 so that the photosensitive member 1 rotates with grain. That is, the charging roller 2 is rotated in a direction substantially identical to a slanting direction of the projections formed at the peripheral surface of the charging roller 2. The surface treatment layer 23 also includes a treatment layer treated with a desired surface treating liquid or desired electromagnetic irradiation, in addition to the above-described polishing treatment layer.

The charging roller 2 is, different from an expensive multi-layer charging roller, characterized by a simple constitution, so that it can be designed so as to satisfy operational requirement by fine adjustment of the surface (post-processing, i.e., polishing in this embodiment).

The core metal (shaft member) 21 is not particularly limited. For example, it is possible to use a core metal consisting of a solid metal cylinder or a hollow metal cylinder.

The electroconductive elastic layer 22 is formed directly on the outer peripheral surface of the core metal 21 or through another electroconductive under coating layer 25 (omitted from the description).

The electroconductive elastic layer 22 is not particularly limited but may be formed by a solid member such as rubber or thermoplastic elastomer which have been conventionally used as a material for an elastic layer of a charging member. Specifically, it is possible to use polyurethane, silicone rubber, butadiene rubber, isoprene rubber, chloroprene rubber, styrene-butadiene rubber, and ethylene-propylene rubber. Further, it is also possible to use ethylene-propylene-dien rubber (EPDM), polynorbornene rubber, styrene-butadiene-styrene rubber, epichlorohydrin rubber (CHR), and acrylic rubber (ACM) These materials are used as a base material for rubber compositions or thermoplastic elastomers. The kinds of these compositions and elastomers are not particularly limited but it is possible to suitably use one species or two or more species of thermoplastic elastomers selected from general-purpose styrene-based elastomers and olefin-based elastomers.

For the electroconductive elastic layer 22, epichlorohydrin (CHR)-based rubber base material is preferred. More specifically, examples of the CHR-based rubber base material may include an epichlorohydrin homopolymer, an epichlorohydrin-ethyleneoxide copolymer, an epichlorohydrin-allyl glicidyl ether copolymer, an epichlorohydrin-ethylene oxide-allyl gricidyl ether terpolymer, and blends of these materials.

The charging roller 2 containing the above-described CHR-based rubber base material and an electroconductive agent is adjusted to have an electric resistance in a range of 10⁴−10⁸ Ω. The resistance value of the charging roller 2 is measured in the following manner.

The photosensitive member 1 of the image forming apparatus is replaced with an aluminum drum. Thereafter, a voltage of 100 V is applied between the aluminum drum and the core metal 21 of the charging roller 2. A value of a current flowing at this time is measured to determine the resistance value of the charging roller 2.

The above-described electroconductive agent is not particularly limited. As the electroconductive agent, it is possible to use lauryltrimethylammonium, stearyltrimethylammonium, octadodecyltrimethylammonium, dodecyltrimethylammonium, and hexadecyl-trimethylammonium. It is also possible to use cationic surfactants including quaternary ammonium salts, such as perchlorate salts, chlorates, fluoroborates, ethosulfates, and benzyl halide salts (e.g., benzyl bromide salt, benzyl chloride salt), of modified aliphatic acid dimethylethylammonium. It is also possible to use anionic surfactants such as aliphatic sulfonates, fatty alcohol sulfates, ethylene oxide adducts of fatty alcohol sulfates, fatty acid phosphates, and ethylene oxide adducts of fatty acid phosphate. It is also possible to use antistatic agents including ampholytic surfactants such as various betaines and nonionic surfactants such as fatty acid ethylene oxide adducts, polyethylene glycol fatty acid esters, and polyhydric alcohol fatty acid esters. It is also possible to use electrolytes including quaternary ammonium salts and metal salts of first group of the periodic system (e.g., Li⁺, Na⁺, K⁺) such as LiCF₃SO₃, NaClO₄, LiAsF₆, LiBF₄, NaSCN, KSCN, and NaCl. It is also possible to use metal salts of second group of the periodic system (e.g., Ca²⁺, Ba²⁺) such as Ca(ClO₄)₂. It is also possible to use the above-described antistatic agents which further have a group having at least one active hydrogen, capable of reacting with isocyanate, such as hydroxyl group, carboxyl group, primary amine group, or secondary amine group.

Further, it is possible to use complexes of the above-described compounds with polyhydric alcohols such as 1,4-butanediol, ethylene glycol, polyethylene glycol, propylene glycol, and polypropylene glycol, and their derivatives. It is also possible to use ion conductive agents such as complexes of the above-described compounds with monools such as ethylene glycol monomethyl ether and ethylene glycol monoethyl ether. It is also possible to use electroconductive carbons such as Ketjen black EC and acetylene black. It is also possible to use carbons for rubber such as SAF (Super Abrasion Furnace), ISAF (intermediate Super Abrasion Furnace), HAF (High Abrasion Furnace), FEF (Fast Extruding Furnace), GPF (General Purpose Furnace), SRF (Semi Reinforcing Furnace), and MT (Medium Furnace). It is also possible to use oxidized compounds of carbon for color (ink), pyrolytic carbon, natural graphite and artificial graphite, and metal oxides and metals such as tin oxide, titanium oxide, zinc oxide, nickel, copper, silver, and germanium. It is also possible to use electroconductive polymers and the like such as polyaniline, polypyrrole, and polyacethylene.

Particularly, as the electroconductive agent, the ion conductive agent such as quaternary ammonium salt is preferred. It is further preferable that the ion conductive agent is used in combination with the electroconductive carbon causing less ambient condition variation. Incidentally, herein, the quaternary ammonium salt refers to not only a pure salt but also quaternary ammonium salt to which perchlorate is ionically bonded.

A compounding amount of the above-described electroconductive agent may preferably be set at 0.5-5 wt. parts per 100 wt. parts of a rubber component (containing, e.g., CHR and ACM).

The electroconductive elastic layer 22 contains liquid rubber. The liquid rubber has a number-average molecular weight of 1000 or more and a viscosity of 1000 Pa.s or less. s the liquid rubber, it is possible to use at least one species of compounds selected from the group consisting of liquid polyolefin, liquid polychloroprene, liquid polybutadiene-acrylonitrile, liquid polyester, and liquid polyether.

Such a liquid rubber has a large molecular weight to some extent, thus being less bleeded. However, the liquid rubber is capable of moderately lower Mooney viscosity, thus improving moldability (formability).

It is desirable that the liquid rubber is used in an amount of 1-20 wt. %, preferably 2-10 wt. %, per the epichlorohydrin-based rubber base material.

The electroconductive elastic layer 22 is formed by vulcanizing the above-compounded rubber composition, followed by molding (forming). A vulcanizing method is not particularly limited. For example, peroxide vulcanization or sulfur vulcanization may be used but sulfur vulcanization is preferred in order to retain a low resistance.

Particularly, a chlorine-abstracting cross-linker, at least one species of sulfur and a vulcanizing accelerator containing sulfur, and zinc oxide may preferably be used for co-cross-linking. As the chlorine abstracting cross-linker, it is possible to use a thiourea compound, a triazine compound, and a quinoxaline compound. Specifically, it is possible to use ethylenethiourea and 2,3,6-trimercapto-S-triazine.

As a result, it is possible to improve a demolding property and a (processing) formability. Further, secondary (post) vulcanization can be reduced, so that a resultant elastic member has small permanent compression set from an initial stage. In addition, processing formability such as a property during polishing processing or the like is satisfactory, so that it is possible to advantageously compensate for a lowering in processability due to addition of the liquid rubber. That is, the polishing processability after the molding (forming) is improved and surface smoothness after the polishing is satisfactorily retained. Further, it is possible to achieve an effect of improving effect of improving anti-mold contamination property, anti-corrosive property of the core metal, and moldability.

Further, performing the co-cross-linking with zinc oxide, the low resistance can be advantageously retained.

The cross-linker may preferably added in an amount of 0.3-5 wt. % per the above-described epichlorohydrin-based rubber base material. The sulfur and/or the vulcanization accelerator containing sulfur may preferably be added in an amount of 0.1-5 wt. % per the epichlorohydrin-based rubber base material. Further, the zinc oxide may preferably be added in an amount of 0.1-20 wt. %, more preferably 0.1-10 wt. %, per the epichlorohydrin-based rubber base material.

A thickness of the electroconductive elastic layer 22 is generally set at 1-10 mm, preferably about 2-4 mm.

The surface treatment layer 23 formed on the outer peripheral surface of the above-described electroconductive elastic layer 22 as an outermost layer may be a known layer used at the surface of the charging roller. Specifically, it is possible to use a layer principally comprising N-methoxymethyl nylon described above or a layer containing an isocyanate compound as a main component. The layer containing the isocyanate compound as the main component is preferred in consideration of a charging member which is not contaminated even in contact with the organic photosensitive member and has less environmental dependency of the electric characteristic and an excellent anti-filming property of a toner component. Only the layer containing the isocyanate compound as the main component may be used but it is also possible to add therein at least one of an electroconductivity-imparting agent and at least one species of polymers selected from the group consisting of acrylic fluorine-containing polymer and acrylic silicone-based polymer.

As the isocyanate compound, it is possible to use 2,6-tolylenediisocyanate (TDI), 4,4′-diphenylmethane diisocyanate (MDI), paraphenylene diisocyanate (PPDI), 1,5-naphthalene diisocyanate (NDI), 3,3-dimethyldiphenyl-4,4′-diisocyanate (TODI), and multimers and modified products of these isocyanates.

The acrylic fluorine-containing polymer and the acrylic silicone-based polymer are soluble in a predetermined solvent and is capable of being chemically bonded to the isocyanate compound through reaction with the isocyanate compound. The acrylic fluorine-containing polymer is, e.g., a solvent-soluble fluorine-containing polymer having a hydroxyl group, an alkyl group or a carboxyl group. Examples thereof may include a block copolymer of acrylate and acrylic acid alkyl fluoride and derivatives thereof. Further, the acrylic silicone-based polymer is a solvent-soluble silicone-based polymer. Examples thereof may include a block copolymer of acrylate and acrylic acid siloxane ester.

In the case where one or two or more species of such polymers are contained or mixed in a surface treatment liquid and used for the surface treatment, it is preferable that an amount of the polymer(s) in the surface treatment liquid may be 2-30 wt. % per the isocyanate component. This is because when the amount is small, an effect of retaining carbon black in the surface treatment liquid is decreased and because when the amount is excessively large, the isocyanate component is relatively decreased in amount, so that an effective surface treatment layer cannot be formed.

The surface treatment liquid contains carbon black as the electroconductive agent. The kind of the carbon black is not particularly limited but it is possible to use, e.g., “Ketjen Black” (mfd. by Lion Corporation) and “TOKABLACK#5500” (mfd. by Tokai Carbon Co. Ltd.). An amount of the carbon black in the surface treatment liquid may preferably be 10-40 wt. % per the isocyanate component. This is because an effective electroconductive characteristic cannot be achieved when the amount is less than 10 wt. % and a problem of falling-off or the like undesirably occur when the amount is excessively large.

The surface treatment liquid further contains a solvent for dissolving the acrylic fluorine-containing polymer, the acrylic silicone-based polymer and the isocyanate compound. The solvent is not particularly limited but an organic solvent such as ethyl acetate, methyl ethyl ketone (MEK), or toluene may be used. It is preferable that a thickness of the surface treatment layer may be set at 5-30 μm, particularly 7-23 μm.

For production of the charging roller 2, the above-described materials for constituting the electroconductive elastic layer 22 are kneaded. The kneaded product is extruded in a cylindrical shape having, e.g., an outer diameter of 16 mm and an inner diameter of 7.5 mm (but varying depending on a diameter required) and then subjected to vulcanization to provide a primary vulcanization tube for the electroconductive elastic layer 22.

Then, into the primary vulcanization tube for the electroconductive elastic layer 22, the shaft of the electroconductive support 21 on which an adhesive is applied is inserted, followed by secondary vulcanization in an oven or the like to obtain a charging roller in an un-polished state.

The surface of this charging roller (the surface of the electroconductive elastic layer) is polished with a grindstone to place the charging roller in a desired surface-treated state, i.e., a surface-treated state with grain of polish trace. Therefore, as shown in FIGS. 1 to 4, on the charging roller surface, pits and projections are alternately and continuously formed so that a direction of almost all the projections is slanted with respect to a radial direction of the charging roller and the slanted directions of almost all the projections are uniform.

In this state, the charging roller has a surface roughness of 1-20 μm in terms of Rz (JIS B6101). It is difficult to realize a surface roughness of less than 1 μm in view of accuracy of the grindstone, so that the grindstone itself is required to have high accuracy, thus failing to provide cost advantages. Further, when the charging roller surface is roughened to have a surface roughness of more than 20 μm.

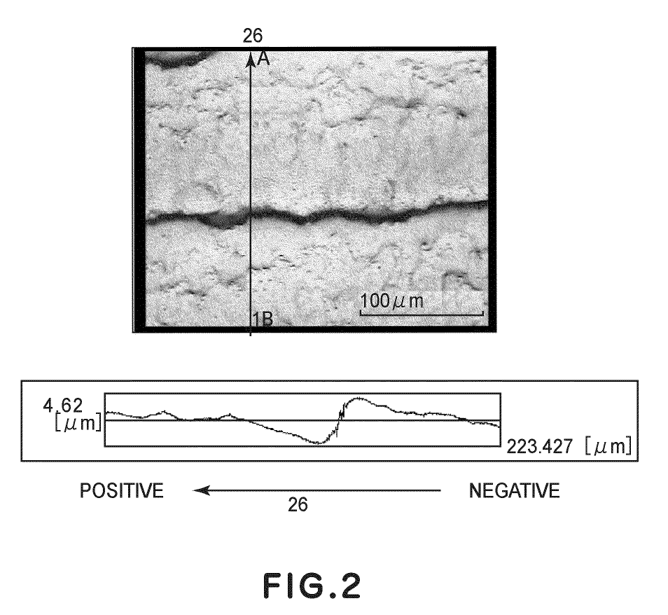

The definition of the grain of polish trace 24 will be specifically described. FIG. 2 includes a photograph, of a surface state of an actually polished charging roller, taken by an ultradeep shape measuring microscope (“VK8510”, mfd. by KEYENCE CORPORATION) and a profile of the grain of polish trace.

The shape of the grain of polish trace is actually profiled along an arrow 26 shown on the photograph. A direction of the arrow 26 is referred to as a positive direction and an opposite direction to the direction of the arrow 26 is referred to as a negative direction, thus representing the direction of the grain of polish trace 24. With respect to a rotational direction of the charging roller 2, the charging roller 2 is brought into contact with the photosensitive member 1 so as to be rotated in the positive direction (in which the photosensitive member 1 contacts the grain of polish trace 24 and rotates with grain).

A molded profile of the grain of polish trace 24 is shown in FIG. 3. As shown in FIG. 3, through a vertex 32 of the grain of polish trace 24, a line 32 is drawn toward a center of the charging roller. A distance between the vertex 32 and a left-hand bottom 34 and a distance between the vertex 32 and a right-hand bottom 33 and different from each other. Further, an angle θ1 formed between the line 32 and a line connecting the vertex 32 to the left-hand bottom 34 and an angle θ2 formed between the line 32 and a line connecting the vertex 32 to the right-hand bottom 33 are different from each other. Such a shape that a portion defined by the vertex 32 and the bottoms 33 and 34 is continuously connected is considered as the shape of the grain of polish trace 24.

A shaft side (connecting the vertex 32 and the left-hand bottom 34) of the grain of polish trace 24 may preferably less contact the photosensitive member surface with respect to the rotational direction of the photosensitive member. This is because the bottom 34 is less contaminated with an external additive or the like. This is also because, on the other hand, when the short side is liable to contact the photosensitive member surface with respect to the rotational direction of the photosensitive member, a contaminant such as the additive or the like is liable to remain at the bottom 34.

In this embodiment, the angle θ1 formed between the line 31 and a long side (connecting the vertex 32 and the right-hand bottom 33) is 30 to 80 degrees. The angle θ2 between the line 31 and the short side is −10 to 30 degrees. Further, a stepped portion length (height) 36 may be 1-20 μm, preferably 8-12 μm. Further, a spacing 35 between adjacent portions of the grain of polish trace 24 may preferably be 100-200 μm.

### [Cleaning Member 41]

FIG. 4 is a schematic cross-sectional view of a rotatable brush 41 as a charging roller cleaning member for cleaning the charging roller 2 (hereinafter referred to as a “brush roller”).

This brush roller 41 is, as shown in FIGS. 4 and 5, shaped in such a manner that a brush pile fabric 49 including a base cloth 42 in which fibers (brush fibers) 44 having predetermined fiber fineness and fiber density is helically wound and fixed around a shaft (rotatable shaft) 43 and an outer diameter of the brush pile fabric 49 is uniformized as a whole. Then, straight brush fibers 44 extending in a radial direction is subjected to fiber-slanting processing so that the brush fibers are slanted toward the rotational direction of the brush roller 41. The slanting-processed brush roller 41 has directionality (codirectional (with grain) or counter directional (against grain)) with respect to a circumferential direction of the brush roller 41. In this embodiment, the rotational direction of the brush roller 41 is a codirectional direction (with grain) which is substantially opposite from the codirectional direction (with grain) of the charging roller 2 provided with the grain of polish trace 24.

The brush roller 41 is rotatably supported via bearing members at both end portions of the shaft 43, which is provided in substantially parallel to the axial line (shaft) of the charging roller 2, so that the brush portion contacts the surface of the charging roller 2 with a substantially uniform pressure with respect to the axial direction. The brush roller 41 is rotationally driven at a predetermined speed by a driving motor M′ (FIG. 10) as a rotating mechanism. The rotational direction of the brush roller 41 is opposite from that of the charging roller 2 at a contact portion between the brush roller 41 and the charging roller 2. By this rotation of the brush roller 41 in the direction opposite from that of the charging roller 2 rotated by the rotation of the photosensitive member 1, the surface of the charging roller 2 and the surface of the brush roller 41 are moved in contact with each other as shown in FIG. 4. As a result, the surface of the charging roller 2 provided with the grain of polish trace 24 is rubbed, in the counterdirectional direction (against grain) of the charging roller 2, with the brush fibers 44 rotated in the codirectional direction (with grain) of the brush roller 41.

As described above, the present invention is characterized in that the brush fibers 44 are slanted with respect to the grain of polish trace 24 of the charging roller 2 so as to remove the contaminant such as the external additive from the pits of the grain of polish trace 24. Further, the rotational direction of the brush roller 41 is opposite from (do not follow) the rotational direction of the charging roller 2 and a difference in peripheral speed between the brush roller 41 and the charging roller 2 is provided, so that the external additive which is liable to enter the grain of polish trace 24, particularly the pits is removed.

The shaft 43 is not particularly limited similarly as in the case of the shaft (core metal) 21 of the charging roller 2 but it is possible to use a core metal constituted by a solid metal cylinder or a hollow metal cylinder.

As the brush fibers 44, it is possible to utilize generally used fibers alone or fibers in which an electroconductive against is dispersed. As a material for the fibers, it is possible to use polyamide (nylon), acrylic, polyester, rayon, and vinylon. As the electroconductive agent, it is possible to use metals such as aluminum, iron, copper, and nickel; electroconductive oxides such as zinc oxide, tin oxide, and titanium oxide; and carbon fine particles such as carbon black, graphite, and carbon nanotube.

From viewpoints of easy fiber-slanting processing and less influence in various temperature and humidity environments, fibers of polyamine (nylon 6) in which carbon black particles are dispersed are preferred.

The fiber fineness of the brush fibers 44 may preferably be 1 denier or more and 20 deniers or less. When the fineness is less than 1 denier, sufficient slanted fibers cannot be formed, so that the fibers are liable to be bent easily. Further, when the fineness is more than 20 deniers, the fibers rather lose flexibility as a fiber, so that it is difficult for the resultant brush roller to be used as the cleaning member.

The fiber density of the brush fibers 44 may preferably be 80 kF/inch² or more and 300 kF/inch² or less, i.e., 80×10³ filaments (fibers)/inch² or more and 300×10³ filaments (fibers)/inch² or less. When the density is less than 80 kF/inch², the brush fibers 44 non-uniformly contact the charging roller 2, so that cleaning power is also non-uniform. Further, when the density is more than 300 kF/inch².

The brush fibers 44 may preferably have a length of 0.5 mm or more and 5 mm or less. When the length is less than 0.5 mm, due to axial crossing rennet between the charging roller 2 and the brush roller 41, contact non-uniformity of the brush roller 1 with respect to the charging roller 2 is liable to occur. Further, when the length is more than 5 mm, free ends of the brush fibers 44 become limp, so that the contaminant cannot be removed satisfactorily.

A fiber-slanting angle θ3 is defined as an angle formed between a line of a slanted fiber and a perpendicular line 46 with respect to a tangent line 45 crossing the perpendicular line 46 at a point from which the slanted fiber extends. That is, each of the brush fibers 44 is obliquely slanted (obliquely extends) with respect to the vertical line with respect to the tangent line of a rotating circle of the brush roller 41.

In this case, the fiber-slanting angle θ3 may preferably 5 degrees or more and 60 degrees or less, i.e., an angle formed between the tangent line 45 and the slanted fiber may preferably be 30 degrees or more to 85 degrees or less. When the fiber-slanting angle θ3 is less than 5 degrees, the resultant state is substantially identical to a straight fiber state (radially extending state), so that the free ends of the brush fibers 44 cannot satisfactorily enter the pits of the grain of polish trace 24 of the charging roller 2, thus failing to satisfactorily remove the external additive or the like. When the fiber-slanting angle θ3 is more than 60 degrees, the brush fibers 44 are rather slanted excessively to fail to contact the charging roller 2 satisfactorily, so that the brush roller 41 does not function as the cleaning member.

The fiber-slanting processing of the brush roller 41 is, e.g., performed in such a manner that a straight fiber-type brush formed by radially planting straight brush fibers in a rotatable shaft is intended, while being rotated, into a pipe having an inner diameter corresponding to a diameter of brush fibers after fiber-slanting processing and is left standing to reform the brush. Further, it is also possible to employ a method of reforming the brush under heating after the straight film-type brush is similarly inserted into the pipe and a method of winding a sheet, in which fibers are obliquely planted with a slanting angle in advance, about a rotatable shaft.

The brush roller 41 may preferably have a brush (fiber) penetration depth 61 of 0.5 mm or more and 2 mm or less. When the penetration depth is less than 0.5 mm, due to an eccentric shaft or the like, a fur tip does not satisfactorily contact the charging roller 2 in some cases. Further, when the penetration depth is more than 2.0 mm, the fur tip is in a bent state, so that a contaminant 62 or the like stuck to the pits cannot be removed.

The brush roller 41 may preferably have a pressing (urging) force (fur tip force) against the charging roller 2 of 88 mN/cm or more and 250 mN/cm or less. When the brush roller 41 is pressed against the charging roller 2 with a pressing force of less than 88 mN/cm, the contaminant entering the pits of the grain of polish trace 24 does not move outside the pits. Further, when the brush roller 41 is pressed against the charging roller 2 with a pressing force of more than 250 mN/cm, the brush roller 41 is pressed against the charging roller 2 with a considerably large pressing force, with the result that the charging roller 2 is damaged with respect to a direction different from the direction of the grain of polish trace. The contaminant enters a damaged portion, so that the contaminant cannot be removed from the damaged portion.

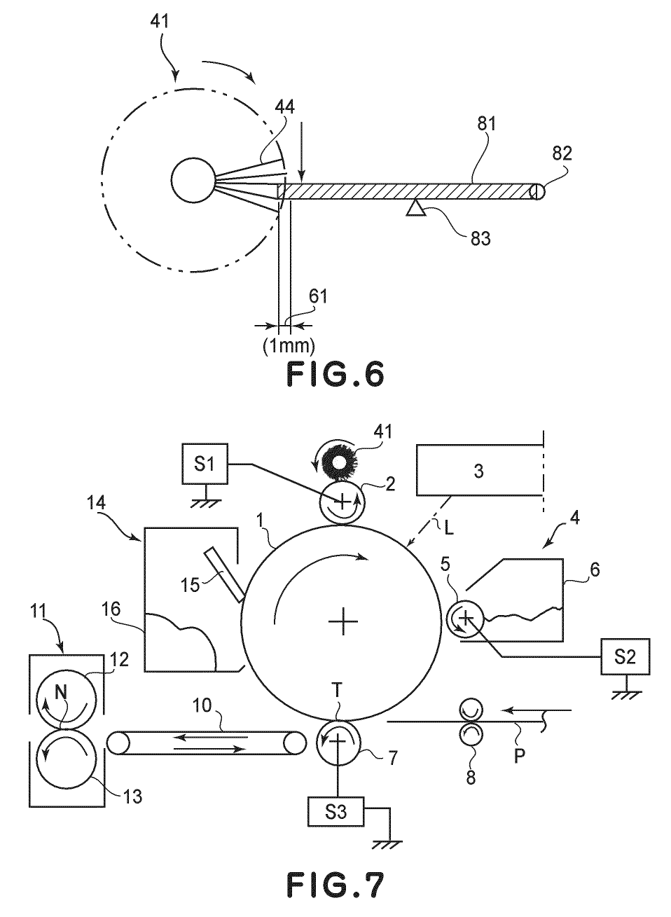

A measuring method of the pressing force (fur tip force) is illustrated in FIG. 6. Here, a width refers to a length with respect to a direction perpendicular to the figure (FIG. 6), a depth refers to a length with respect to a left-right direction in FIG. 6, and a thickness refers to a length with respect to a vertical direction in FIG. 6. An aluminum plate 81 having a width of 100 mm, a depth of 55 mm, and a thickness of 1 mm is rotatably supported at a supporting point (fulcrum) 82 which is an end point opposite from the other end point contacting the brush roller 41. In a state in which a tangent line at the other end point (contact point) is perpendicular to the aluminum plate 81 with respect to the left-right direction in FIG. 6, a load cell 83 is disposed under the aluminum plate 81. In this case, a distance from the supporting point 82 is 50 mm. When the brush roller 41 is caused to interfere with the aluminum plate 81 with a brush penetration depth 61 of 1 mm while being rotated at a peripheral speed of 256 mm/sec, a load is detected by the load cell 83. A value obtained by dividing a detected load value by the width of the aluminum plate of 100 mm, i.e., a value of load per unit length (1 cm) with respect to a width direction is determined as the pressing force (fur tip force).

### [Developing Device 4]

As a developing method of an electrostatic latent image formed on the photosensitive member includes a method in which the developing device 4 is used for development in a non-contact state with the photosensitive member 1 (one-component non-contact development), a method in which the developing device 4 is used for development in a contact state with the photosensitive member 1 (one-component contact development), a method in which a mixture of toner particles with a magnetic carrier is used as a developer and the developer is conveyed by magnetic force and then is subjected to development in a contact state with the photosensitive member 1 (two-component contact development), and a method in which the two-component developer is subjected to development in a non-contact state with the photosensitive member 1 (two-component non-contact development). Any of these methods can be suitably used.

In this embodiment, as the toner used for developing the electrostatic latent image, toner particles which are constituted by a coloring component, a binder resin material, a copolymerized petroleum resin material of aliphatic hydrocarbon and aromatic hydrocarbon having 9 or more carbon atoms, a wax, a magnetic material, and the like and has a particle size of 7 μm are used.

As the binder resin material, a conventionally known resin material can be used. For example, it is possible to use polyester resin, styrene resin, styrene-(meth)acrylic resin, styrene-butadiene resin, epoxy resin, polyurethane resin, and the like. The polyester resin may be synthesized by polycondensation of a polyol component and a polycarboxylic acid component. As the polyol component, it is possible to use ethylene glycol, propylene glycol, 1,3-butanediol, 1,4-butanediol, 2,3-butanediol, diethylene glycol, triethylene glycol, 1,5-butanediol, 1,6-butandiol, neopentyl glycol, cyclohexanedimethanol, hydrogenated bisphenol A, bisphenol A ethylene oxide adduct, bisphenol A propylene oxide adduct, and the like. As the polycarboxylic acid component, it is possible to use maleic acid, fumaric acid, phthalic acid, isophthalic acid, terephthalic acid, succinic acid, dodecenylsuccinic acid, trimellitic acid, pyromellitic acid, cyclohexanetricarboxylic acid, 2,5,7-naphthalenetricarboxylic acid, 1,2,4-naphthalenetricarboxylic acid, 1,2,5-hexanetricarboxylic acid, 1,3-dicarboxyl-2-methylenecarboxypropanetetramethylene carboxylic acid, and anhydrides of these compounds.

The copolymerized petroleum resin material of aliphatic hydrocarbon and aromatic hydrocarbon having 9 or more carbon atoms to be contained in the toner functions as a dispersion aid of the wax. For this reason, while dispersibility of the wax in the resin material and low-temperature fixability are retained, it is possible to remarkably improve an anti-offset property, a pulverization property, a degree of lowering in image density due to charge deterioration by filming of the wax on a developing sleeve, and a degree of an occurrence of image defect due to filming on the photosensitive member. A similar effect can be achieved also in the case where the copolymerized petroleum resin material is added into the magnetic developer.

The copolymerized petroleum resin material is synthesized from diolefin and monoolefin, as source materials, contained in cracked distillate which is a by-product obtained from an ethylene plant for producing ethylene, propylene, and the like through steam cracking of petroleum. It is desirable that an aliphatic hydrocarbon monomer and an aromatic hydrocarbon monomer which are shown below are copolymerized to obtain the petroleum resin material. The aliphatic hydrocarbon monomer is at least one species of monomers selected from the group consisting of isoprene, piperylene, 2-methyl-butene-1, and 2-methylbutene-2. The aromatic hydrocarbon monomer is at least one species of monomers selected from the group consisting of vinyltoluene, α-methyl styrene, indene, and isopropenyl toluene.

It is more preferably that coloring of the resin material and odor during heating can be suppressed at low levels when a pure monomer having a high monomer purity is used as the aromatic hydrocarbon monomer. The aromatic hydrocarbon monomer may preferably have a purity of 95% or more, more preferably 98% or more. The aromatic hydrocarbon monomer is consisting of a monomer having 9 or more carbon atoms.

A copolymerized petroleum resin material obtained from this monomer and the aliphatic hydrocarbon monomer is, compared with a copolymerized petroleum resin material obtained from an aromatic hydrocarbon monomer having less than 9 carbon atoms and the aliphatic hydrocarbon monomer, higher in compatibility with the binder resin material such as polyester resin. Further, a a constitution of the copolymer of the aliphatic hydrocarbon monomer and the aromatic hydrocarbon monomer having 9 or more carbon atoms in order to satisfy the pulverization property and heat storage stability of the toner, it is preferable that an amount of the aromatic hydrocarbon monomer is large. However, when the amount of the aromatic hydrocarbon monomer is excessively large, dispersibility of a parting agent is lowered. On the other hand, when an amount of the aliphatic hydrocarbon monomer is excessively large, the heat storage stability or the like is lowered. For these reasons, a weight ratio between the aromatic hydrocarbon monomer amount and the aliphatic hydrocarbon monomer amount may preferably be 99:1 to 50:50, more preferably 98:2 to 60:40, further preferably be 98:2 to 90:10. The petroleum resin material may preferably be used in an amount of 2-50 wt. parts, more preferably 3-30 wt. parts, per 100 wt. parts of the toner binder resin material. When the amount of the petroleum resin material is less than 2 wt. parts, there is no effect in wax dispersion. When the amount of the petroleum resin material exceeds 50 wt. parts, the toner is liable to be excessively pulverized to be decreased in particle size in the developing device, so that fog occurs and an image density is decreased, thus resulting in a possibility of a lowering in developing property.

Further, it is possible to improve flowability of the toner by depositing fine powder as the surface treating agent (external additive) on the surface of the toner. This is because hydrophobic silica or the like is used as such fine powder but when the hydrophobic silica is deposited on the toner surface, it is possible to improve not only the flowability but also a toner cleaning property and a toner charging property.

Further, it is also possible to use fine powder other than the hydrophobic silica. For example, it is possible to use fine powder of titanium oxide, alumina, cerium oxide, aliphatic acid metallic salt, polyvinylidene fluoride, polystyrene, and oxides of metals such as magnesium, zinc, aluminum, cobalt, iron, zirconium manganese, chromium, cerium, strontium, tin, and the like. Further, it is possible to use fine powder of inorganic oxides which are combined metal oxides such as calcium titanate, magnesium titanate, strontium titanate, barium titanate, calcium zirconate, barium zirconate, barium stagnate, calcium stannate. It is also possible to use carbonate compounds such as calcium carbonate, magnesium carbonate, barium carbonate, and the like. Of these compounds, the hydrophobic silica is frequently used for color toner and strontium titanate is frequently used for monochromatic toner.

The surface treating agent is generally used in an amount of 0.1-20% by weight per 100 wt. parts of the toner.

The above-described abrasive particles (agent) are used as the surface treating agent to further enhance an effect. However, as far as the abrasive agent goes, its amount is required to be 1% by weight or less. When the abrasive agent is added in an amount of more than 1% by weight, it influences lowerings in developing property and image density.

Hereinbelow, experimental examples will be described specifically. In the experimental examples, verification of the cleaning property was conducted.

### EXPERIMENTAL EXAMPLE 1

### 1) Preparation of Charging Roller 2

A rubber composition was prepared by using the following ingredients as materials for forming the electroconductive elastic layer 22.

| | | |
|---|---|---|
| Epichlorohydrin rubber | 100 | wt. parts |
| Liquid polychloroprene | 6 | wt. parts |
| Thiourea compound | 2 | wt. parts |
| Sulfur | 0.3 | wt. part |

After an adhesive was applied onto an outer peripheral surface of a core metal (rotatable shaft) 11 consisting of a metal shaft having a diameter of 8 mm, the core metal 11 was set in a metal mold for forming a roller and kept at 70° C. Into the metal mold, the above-prepared rubber composition was injected, followed by reaction and curing for about 10 minutes to obtain the electroconductive elastic layer 22 as a base material for the charging roller 2. The resultant roller structure was removed from the metal mold and aged for about 24 hours at room temperature. A diameter of the roller structure was 15 mm. This roller structure was subjected to surface polishing by a polishing machine to obtain a charging roller 2 having a grain of polish trace 24.

The grain of polish trace 24 of the charging roller 2 had a surface roughness (Rz) of 10 μm, a stepped portion length (height) 36 of 11 μm, a width 35 of the grain of polish trace 24 of 150 μm, θ1 of 60 degrees, and θ2 of 5 degrees.

### 2) Preparation of Brush Roller 41

The brush roller 41 as a cleaning member to be brought into contact with the charging roller 2 was prepared in the following manner.

As a base cloth (thickness: 0.5 mm) 42, a brush pile fabric (base material) 49 planted with brush fibers 44 which have a fiber fineness of 6 deniers, a fiber density of 160 kF/inch² and a length of 1 mm and were formed of nylon (in which carbon black was mixed) was cut into an elongated shape. The elongated-shaped base material 49 was wound helically about a core metal 43 having a diameter of 8 mm without overlapping as shown in FIG. 5 to prepare a brush roller having an outer diameter of 11 mm. This brush roller was placed in a metal mold having a diameter of 10 mm and was heated with 70° C.-steam for 30 minutes while being rotated at a speed of 10 rpm, followed by cooling and removal from the metal mold to prepare a fiber-slanted brush roller 41. The resultant brush roller 41 had a diameter of 10 mm, a slanting angle θ3 of 20 degrees, and a pressing force (fur tip force) measured of o147 mN/cm.

### 3) Preparation of Photosensitive Member 1

A photosensitive member 1 intended to extend service life was prepared as follows.

As a supporting member (support) 51, an aluminum cylinder (thrust length: 360 mm) having a diameter of 30 mm was used.

Paint for an electroconductive layer was prepared in the following manner.

| | | |
|---|---|---|
| Electroconductive titanium oxide powder coated | 50 | wt. parts |
| with 10%-antimony oxide-containing tin oxide | | |
| Phenolic resin | 25 | wt. parts |
| Methyl cellosolve | 20 | wt. parts |
| Methanol | 5 | wt. parts |
| Silicon oil (polydimethylsiloxane-polyoxy-alkylene | 0.002 | wt. part |
| copolymer; average molecular weight: 3000) | | |

These ingredients were dispersed for 2 hours in a sand mill device using glass beads having a diameter of 1 mm to prepare the paint.

This paint was applied onto the above-prepared cylinder 51 by a dip coating method and dried for 30 minutes at 140° C. to form a 20 μm-thick electroconductive layer.

Next, paint for an intermediate layer was prepared by dissolving 5 wt. parts of N-methoxymethyl nylon in 95 wt. parts of methanol. This paint was applied onto the above-prepared electroconductive layer by the dip coating method and dried for 20 minutes at 100° C. to form the intermediate layer. The electroconductive layer and the intermediate layer constituted an undercoating layer 52.

Paint for a charge generating layer was prepared in the following manner.

| | |
|---|---|
| Oxytitanium phthalocyanine having strong peaks at | 3 wt. parts |
| bragg angle (2θ ± 0.2 degree) of 9.0 degrees, 14.2 | |
| degrees, 23.9 degrees, and 27.1 degrees in CuKα X-ray | |
| diffraction | |
| Polyvinyl butyral (“S-LEC BM2”, mfd. by SEKISUI | 3 wt. parts |
| CHEMICAL CO. LTD.) | |
| Cyclohexane | 35 wt. parts |

These ingredients were dispersed for 2 hours in a sand mill device using glass beads having a diameter of 1 mm and then 60 wt. parts of ethyl acetate was added, thus preparing the paint for the charge generating layer.

This paint was applied onto the above-prepared intermediate layer by the dip coating method and dried for 10 minutes at 50° C. to form a 0.2 μm-thick charge generating layer 54.

Then, paint for a charge transport layer was prepared in the following manner.

| | |
|---|---|
| Styryl compound of formula (1) | 10 wt. parts |
| Formula (1): | |
| 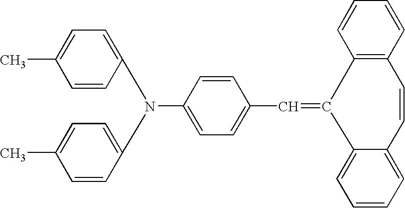 | |
| Polycarbonate resin having a recurring unit of formula (2) | 10 wt. parts |
| Formula (2): | |
| 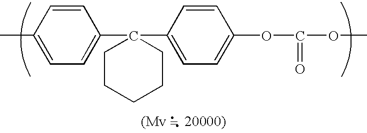 | |

These ingredients were dissolved in a mixture solvent of 50 wt. parts of monochlorobenzene and 30 wt. parts of dichloromethane to prepare the paint for the charge transport layer.

This paint was applied onto the above-prepared charge generating layer by the dip coating method and dried for 1 hour at 120° C. to form a 20 μm-thick charge transport layer 55.

Paint for a surface protection layer was prepared in the following manner.

| | |
|---|---|
| Hole transport compound of formula (3) | 60 wt. parts |
| Formula (3): | |
| 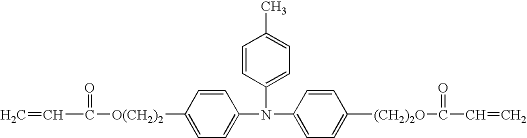 | |

This compound was dissolved in a mixture solvent of 50 wt. parts of monochlorobenzene and 50 wt. parts of dichloromethane to prepare the paint for the surface protection layer.

In the paint for the surface protection layer, tetrafluoroethylene resin material as fluorine-containing resin particles was contained in an amount of 30 wt. % per the entire weight of the surface protection layer.

The paint was coated on the above-prepared charge transport layer 55 and thereafter was irradiated with electron beam in an atmosphere of oxygen concentration of 10 ppm and under a condition of an acceleration voltage of 150 kV and exposure of 50 kGy. Then, in the same atmosphere, the coating was subjected to heat treatment for 10 minutes under a condition such that a temperature of a photosensitive member was 100° C. to form a 5 μm-thick surface protection layer 56, thus preparing a function-separated type electrophotographic photosensitive member 1.

### 4) Durability Test

The above-described charging roller 2, photosensitive member 1, and brush roller 41 were incorporated in a copying machine (“iR2270”, mfd. by CANON KABUSHIKI KAISHA). A durability test on 150×10³ sheets was carried out in a high-humidity environment (25° C., 80% RH) and under a condition of rotational speed of the charging roller 2 of 140 mm.sec and a rotational speed of the brush roller 41 of 143 mm/sec (peripheral speed difference of about 2%).

As a result, a charging characteristic was capable of being retained for a long term and there was no occurrence of image defect due to charging roller contamination.

### EXPERIMENTAL EXAMPLE 2

### 1) Preparation of Charging Roller 2

The charging roller 2 prepared in Experimental Example 1 was, after being polished, subjected to surface treatment with the following surface treating liquid.

The surface treating liquid was prepared by dispersing and mixing the following ingredients in a ball mill for 3 hours.

| | | |
|---|---|---|
| Ethyl acetate | 100 | wt. parts |
| Isocyanate compound | 20 | wt. parts |
| Acethylene black | 5 | wt. parts |
| Acrylicsilicone polymer | 1 | wt. part |

While this surface treating liquid was kept at 23° C., the charging roller 2 prepared in Experimental Example 1 was dipped in the surface treating liquid for 10 seconds and heated for 1 hour in an oven kept at 120° C. to prepare a charging roller 2 treated with the surface treating liquid.

This charging roller 2 was provided with grain of polish trace 24 having a surface roughness (Rz) of 8 μm, a stepped portion length (height) 36 of 7 μm, a width 35 of the grain of polish trace 24 of 170 μm, θ1 of 70 degrees, and θ2 of 2 degrees.

### 2) Preparation of Brush Roller 41

A fiber-slanted brush roller 41 wa prepared in the same manner as in Experimental Example 1 except that, with respect to the brush roller 41 of Experimental Example 1, the fiber fineness of the brush fibers 44 was changed from 6 deniers to 4 deniers, the fiber density was changed from 160 kF/inch² to 180 kF/inch², the length was changed from 1 mm to 2 mm, and the material was changed from the nylon to polyester.

The resultant brush roller 41 had a diameter of 11 mm, a fiber-slanting angle θ3 of 25 degrees, and a pressing force (fur tip force) measured of 196 mN/cm.

A photosensitive member 1 in this example was identical to that in Experimental Example 1.

### 3) Durability Test

A durability test was conducted in the same manner as in Experimental Example 1 by using the above-prepared charging roller 2, photosensitive member 1, and brush roller 41.

Also in this example, it was possible to retain the charging characteristic for a long term and there was no occurrence of the image defect due to charging roller contamination.

### EXPERIMENTAL EXAMPLE 3

### 1) Preparation of Charging Roller 2

With respect to the charging roller 2 prepared in Experimental Example 1, the ingredients for a rubber portion (electroconductive elastic layer 22) were changed to those shown below.

| | | |
|---|---|---|
| Polyurethane polymer | 100 | wt. parts |
| Lithium perchlorate | 1 | wt. parts |
| Dibutyltin dilaurate | 0.01 | wt. part |
| Electroconductive carbon (Electroconductive agent) | 25 | wt. parts |
| Dicumyl peroxide (Cross-linking agent) | 0.5 | wt. part |

These ingredients were caused to react with 4,4′-diphenylmethane diisocyanate (MDI) for 12 hours at 100° C. to obtain a prepolymer including the electroconductive agent and the cross-linking agent.

This prepolymer was used as the molding material and was subjected to polishing by using the same metal mold as in Experimental Example 1 in the same manner as in Experimental Example 1 except that the rotational speed for polishing was changed to half of that in Experimental Example 1.

A charging roller 2 provided with grain of polish trace was prepared in the same manner as in Experimental Example except for the above-described matters. The charging roller 2 provided with the grain of polish trace had a surface roughness (Rz) of 15 μm, a stepped portion length (height) 36 of 16 μm, a width 35 of the grain of polish trace 24 of 120 μm, θ1 of 55 degrees, and θ2 of 2 degrees.

### 2) Preparation of Brush Roller 41

A fiber-slanted brush roller 41 wa prepared in the same manner as in Experimental Example 1 except that, with respect to the brush roller 41 of Experimental Example 1, the fiber fineness of the brush fibers 44 was changed from 6 deniers to 8 deniers, the fiber density was changed from 160 kF/inch² to 100 kF/inch², the length was changed from 1 mm to 1.5 mm, and the material was changed from the nylon to polyester.

The resultant brush roller 41 had a diameter of 11 mm, a fiber-slanting angle θ3 of 15 degrees, and a pressing force (fur tip force) measured of 245 mN/cm.

A photosensitive member 1 in this example was identical to that in Experimental Example 1.

### 3) Durability Test

A durability test was conducted in the same manner as in Experimental Example 1 by using the above-prepared charging roller 2, photosensitive member 1, and brush roller 41.

Also in this example, it was possible to retain the charging characteristic for a long term and there was no occurrence of the image defect due to charging roller contamination.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 250835/2007 filed Sep. 27, 2007, which is hereby incorporated by reference.

What is claimed is:

1. A charging device comprising:
a charging roller for electrically charging a photosensitive member, said charging roller alternately having pits and projections along a circumferential direction thereof, wherein the projections project in an inclined direction in which the projections are inclined with respect to a radial direction of said charging roller;
a roller rotating mechanism for rotating said charging roller to provide a peripheral movement thereof in a sense from the radial direction toward the inclined direction;
a brush for cleaning said charging roller; and
a brush rotating mechanism for rotating said brush to provide a peripheral movement thereof counterdirectionally with the inclined direction at a position in which said brush and said charging roller contact each other.

2. A device according to claim 1, wherein said brush has been subjected to fiber-slanting processing in which fibers of said brush are slanted toward the rotational direction of said brush.

3. A device according to claim 1, wherein said brush have fibers which have a brush penetration depth of 0.5 mm or more and 2 mm or less, a fiber density of 80 kF/inch² or more and 300 kF/inch² or less, and fiber fineness of 1 denier or more and 20 deniers or less.

4. A device according to claim 1, wherein said charging roller has been subjected to polishing along the circumferential direction of said charging roller.

5. A device according to claim 1, wherein said charging device further comprises an urging mechanism for urging said charging roller against the photosensitive member so as to be rotated by the photosensitive member.

6. A charging device comprising:
a rotatable charging roller, which has been subjected to polishing along a circumferential direction thereof to have pits at a circumferential surface of said charging roller, for electrically charging a photosensitive member;
a brush for cleaning said charging roller; and
a rotating mechanism for rotating said brush so that fibers of said brush enter the pits of said charging roller.

7. A device according to claim 6, wherein said brush has been subjected to fiber-slanting processing in which fibers of said brush are slanted toward the rotational direction of said brush.

8. A device according to claim 6, wherein said brush have fibers which have a brush penetration depth of 0.5 mm or more and 2 mm or less, a fiber density of 80 kF/inch² or more and 300 kF/inch² or less, and fiber fineness of 1 denier or more and 20 deniers or less.
